(19) United States
(12) Patent Application Publication
(10) Pub. No.: US 2026/0222827 A1
(43) Pub. Date: Jul. 30, 2026

(54) INTELLIGENT OPERATIONS HEALTH SCORE WITH TEMPORAL TRACKING IN TELECOMMUNICATION NETWORKS

(71) Applicant: BOOST SUBSCRIBERCO L.L.C., Englewood, CO (US)

(72) Inventor: Sumugam Balachandran, Frisco, TX (US)

(21) Appl. No.: 19/036,584

(22) Filed: Jan. 24, 2025

(51) Int. Cl. H04W 24/02; H04W 28/18

(52) U.S. Cl. CPC H04W 24/02; H04W 28/18

(57) ABSTRACT

Systems and methods to perform temporal operations health score tracking in telecommunication networks. One system may include a processing system comprising one or more electronic processors. The processing system may be configured to receive key performance indicator (KPI) data relating to a plurality of KPIs describing a performance of a telecommunications network. The processing system may be configured to determine, based on the KPI data, a composite score indicative of an overall performance of the telecommunications network. The processing system may be configured to, responsive to determining the composite score, execute an automated action with respect to the telecommunications network.

### BACKGROUND

Wireless networks that transport digital data and telephone calls are becoming increasingly sophisticated. Currently, Fifth Generation (5G) broadband cellular networks are being deployed around the world. These 5G networks use emerging technologies to support data and voice communications with millions, if not billions, of mobile phones, computers, and other devices. 5G technologies are capable of supplying much greater bandwidths than previously available technologies.

The discussion above is merely provided for general background information and is not intended to be used as an aid in determining the scope of the claimed subject matter.

### SUMMARY

Various aspects of the present disclosure relate to intelligent operations health scores with temporal tracking in telecommunication networks, and, in particular, to performing temporal operations health scores tracking in telecommunication networks, including in open radio access network (Open RAN or ORAN) cloud native-5G networks.

According to one aspect of the present disclosure, a system to perform temporal operations health score tracking in telecommunication networks. The system may include a processing system including one or more electronic processors. The processing system may be configured to receive key performance indicator (KPI) data relating to a plurality of KPIs describing a performance of a telecommunications network. The processing system may be configured to determine, based on the KPI data, a composite score indicative of an overall performance of the telecommunications network. The processing system may be configured to, responsive to determining the composite score, execute an automated action with respect to the telecommunications network.

According to another aspect of the present disclosure, a method to perform temporal operations health scores tracking in telecommunication networks. The method may include receiving, with a processing system comprising one or more electronic processors, key performance indicator (KPI) data relating to a plurality of KPIs describing a performance of a telecommunications network. The method may include determining, with the processing system, based on the KPI data, a composite score indicative of an overall performance of the telecommunications network. The method may include, responsive to determining the composite score, executing, with the processing system, an automated action with respect to the telecommunications network.

According to another aspect of the present disclosure, a non-transitory computer-readable medium is provided. The non-transitory computer-readable medium stores instructions that, when executed by one or more electronic processors of a processing system in a telecommunications network, may cause the processing system to perform operations comprising: receiving key performance indicator (KPI) data relating to a plurality of KPIs describing a performance of a telecommunications network; determining, based on the KPI data, a composite score indicative of an overall performance of the telecommunications network; and, responsive to determining the composite score, executing an automated action with respect to the telecommunications network.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3 schematically illustrates an example of a server in accordance with various aspects of the present disclosure.

FIG. 4 schematically illustrates an example of a network performance server in accordance with various aspects of the present disclosure.

FIG. 5 is a flowchart of an example method perform temporal operations health scores tracking in telecommunication networks in accordance with various aspects of the present disclosure.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is directed to wireless communications networks, also referred to herein as telecommunications networks. The wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a Fifth Generation (5G) network, such as, e.g., a 5G cellular network. Such 5G networks, including the wireless communication networks described herein, may comply with industry standards, such as, e.g., the Open Radio Access Network (Open RAN or ORAN) standard that describes interactions between the network and user equipment (UE) (e.g., mobile phones and the like). As another example, the wireless communication networks described herein may comply with other industry standards, such as, e.g., the Distributed Radio Access Network (Distributed RAN or D-RAN) or the like. In some configurations, the wireless communication network may be another type of wireless network, such as, for example, a sixth generation (6G), wireless network.

D-RAN enables the distribution of radio access functions and the separation of control and user plane functions, which allows for the deployment of RAN functions in various locations, such as, e.g., remote radio heads (RRHs) and baseband units (BBUs). The BBUs may process the control plane functions and the user plane functions and the RRHs may handle radio frequency (RF) processing. Accordingly, D-RAN allows for the deployment of virtualized RAN functions such that RAN functions can be executed as software via a cloud infrastructure.

The O-RAN model follows a virtualized model for a 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using computing resources. Such computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as, e.g., Amazon Web Services (AWS), Azure, Google Cloud, or any private or public cloud(s).

Accordingly, the technology disclosed herein provides systems and methods to perform temporal operations health scores tracking in telecommunication networks. In some configurations, the technology disclosed herein provides intelligent operations health scores with temporal tracking for ORAN-Cloud Native-5G networks. For ORAN-Cloud Native-5G network operations with software-defined networking (SDN) based transport network, the technology disclosed herein may allow the identification, through artificial intelligence or machine learning, of anomalies by processing live fault management and KPIs through performance management data. In some configurations, the technology disclosed herein may determine a correlation of alarms, and an associated impact on KPIs for one or more individual subsystems (e.g., a Core subsystem, an Access subsystem, a PaaS subsystem, or a Transport subsystem). Based on such events, including the frequency and overall impact on KPIs thereof, the technology disclosed herein may objectively track and compute overall network health or performance as a composite single score (or set of scores), which may track the overall network health. In some configurations, the technology disclosed herein may allow for composite scores by cluster, AOI, market, or region. The composite score (or set of scores) disclosed herein may represent an operational health score over time that can be tracked, measured, and subjected to continuous improvement to consequently provide better customer experience.

Some approaches of monitoring network health or performance may include providing a user KPI data for a plurality of KPIs, which may result in a large quantity of KPI related data to be interpreted by a user. Such a large quantity of KPI related data may make it difficult or impossible, to determine the overall network health of a telecommunications network with any reasonable accuracy or within a time frame where the information would be useful or actionable. For instance, for a user to determine an overall health or performance of a telecommunications network, the user would have to analyze and interpret that large quantity of KPI related data, including interdependencies between KPIs that may not be known or readily apparent to a user, which may, ultimately, result in the user making an inaccurate, subjective interpretation or determination as to the overall health or performance of the telecommunications network.

Additionally, in some instances, the KPI related data may present an inaccurate or incomplete representation of what is happening within a telecommunications network. As one example, while an accessibility KPI may indicate a degraded user experience with a telecommunications network, end users of the telecommunications network may be able to access a roaming network such that the user experience of those end users is not actually adversely impacted (as suggested by the accessibility KPI). As demonstrated by this example, in some instances, KPI related data may suggest a degraded user experience with a telecommunications network, when, in actuality, due to another factor or characteristic associated with the telecommunications network, user experience is actually not degraded.

The technology disclosed herein advantageously provides improved implementations of performing temporal operations health scores tracking in telecommunication networks. For instance, in some configurations, the technology disclosed herein may generate a composite score indicative of an overall health of a telecommunications network, such that a system and/or user (e.g., a network technician or operator) may have reliable, objective, and accurate information on the telecommunication network health that was not previously available, and on which to take responsive action. The composite score may also be generated in real time or near real time such that a system or user may timely take corrective action, in the event of an indication of poor health or issues. Further, composite scores obtained for a telecommunications network over time (e.g., periodically) may indicate trends or historical information on the health of the telecommunications network.

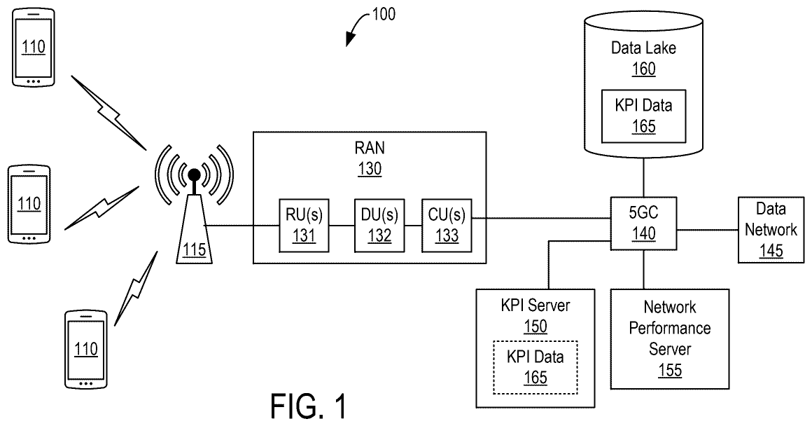

FIG. 1 illustrates an example of a telecommunications network 100 in accordance with various aspects of the present disclosure. In the telecommunications network 100 of FIG. 1, one or more user equipment (UE) 110 may be connected to a wireless access point 115, which in turn may be connected to a radio access network (RAN) 130, including, e.g., one or more radio units (RUS) 131, distributed units (DUs) 132, centralized units (CUs) 133, or a combination thereof. In some configurations, the RAN 130 may be implemented as a virtualized RAN 130. As noted herein, the O-RAN model follows a virtualized model for a 5G wireless architecture in which 5G base stations (e.g., gNBs) are implemented using separate CUs, DUs, and RUs. In some configurations, O-RAN CUs and DUs may be implemented using software modules executed by distributed (e.g., cloud) computing hardware. Virtualization allows for various other components of the cellular network, such as cellular network core functions, to be implemented as code that is executed using computing resources. Accordingly, in some configurations, the RAN 130 may be implemented in accordance with the O-RAN model, such that the RUs 131, the DUs 132, or CUs 133 may be O-RAN RUs, CUs, or DUs. The RAN 130 may provide a connection to a 5G core network (5GC) 140, which in turn may provide a connection to a data network 145, a KPI server 150, a network performance server 155, a data lake 160, or a combination thereof. The data network 145 may be the Internet, an enterprise data network, combinations thereof, or the like. The wireless access point 115 and the RAN 130 may collectively be referred to as a next-generation RAN (NG-RAN).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network, including, e.g., a telecommunication network capable of being virtualized. For instance, in some implementations, the telecommunication network 100 may be implemented using one or more virtualized RAN components, such as, e.g., one or more virtualized RUs, virtualized DUs, virtualized CUs, or a combination thereof. In some configurations, the telecommunication network 100 may be implemented pursuant to the O-RAN model, as described herein. Accordingly, in some instances, the telecommunications network 100 may be an O-RAN telecommunications network.

As used herein, the term “UE” may be one of various types of end-user devices, such as a cellular phone, a smartphone, a cellular modem, a cellular-enabled computerized device, a sensor device, robotic equipment, a vehicle, an Internet of Things (IoT) device, a gaming device, an access point (AP), a two-way radio, a walkie-talkie, or any computerized device capable of communicating via a cellular network. More generally, the UEs 110 can represent any type of device that has an incorporated 5G interface, such as, e.g., a 5G modem. Examples can include a sensor device, an IoT device, a manufacturing robot, an unmanned aerial (or land-based) vehicle, a network-connected vehicle, etc. Depending on the location of individual UEs 110, the UEs 110 may use radio frequency (RF) to communicate with various base stations of a telecommunications network (e.g., the wireless access point 115 of the telecommunications network 100 of FIG. 1). While FIG. 1 illustrates three UEs 110 connected to the wireless access point 115, in practical implementations any number of UEs 110 may be connected to the wireless access point 115 at any given time.

The wireless access point 115 may represent the physical infrastructure (e.g., a 5G tower or base station) to which the UE(s) 110 connects. The wireless access point 115 may be any structure to which one or more antennas are mounted. The wireless access point 115 may be a dedicated cellular tower, a building, a water tower, or any other man-made or natural structure to which one or more antennas can reasonably be mounted to provide cellular coverage to a geographic area.

The wireless access point 115 may include the RU(s) 131. The RU(s) 131 are configured to convert radio signals sent to and received from the antenna(s) into a digital signal. The wireless access point 115 is connected to the RAN components 130 via a fronthaul link over which the digital signals may be communicated. The DU(s) 132 may be connected to the CU(s) 133 via a midhaul link. The CU(s) 133 may be connected to the 5GC 135 via a backhaul link. While FIG. 1 illustrates a single wireless access point 115, in practical implementations the telecommunications network 100 may include any number of wireless access points 115.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center or group of data centers that allows for redundancy, thereby to provide fail-over protection from other availability zones within the same cloud computing region. For example, when a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites. A site may have one DU 132 and a number of RUs 131 (e.g., six RUs 131) assigned to it.

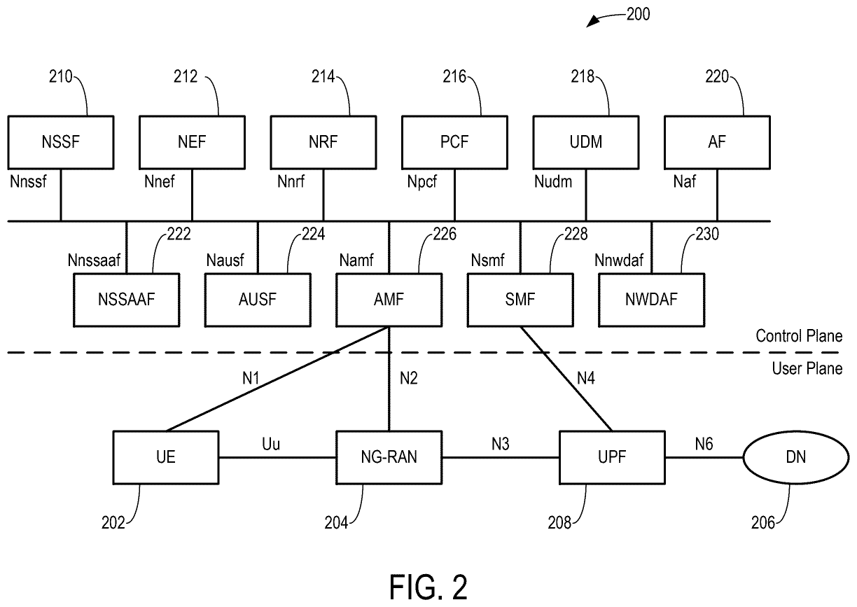

The 5GC 140 provides a plurality of 5G core functions. In the topology of a 5G NR cellular network, 5G core functions of 5GC 140 can logically reside as part of a national data center (NDC). An NDC can be understood as having its functionality existing in a cloud computing region across multiple availability zones. This arrangement allows for load-balancing, redundancy, and fail-over. In local zones, multiple regional data centers can be logically present. Each of regional data centers may execute 5G core functions for a different geographic region or group of RAN components. An example of 5G core components that can be executed within a regional data center (RDC) are described in more detail with regard to FIG. 2. The data network 145 may be the Internet, an enterprise data network, combinations thereof, or the like.

FIG. 2 illustrates an example architecture 200 for a telecommunications network (e.g., the telecommunications network 100 of FIG. 1) in accordance with various aspects of the present disclosure. In some instances, the architecture 200 may be a service-based architecture (SBA), such as, e.g., a SBA based on HTTP2. The architecture 200 may be divided between a control plane (CP) and a user plane (UP). The CP may include a plurality of CP network functions (NFs). The UP may include a UE 202 (e.g., one of the UEs 110 of FIG. 1) connected to an NG-RAN 204, and UP NFs (e.g., a User Plane Function (UPF) 208). In some implementations, using the architecture 200, the UE 202 may access a data network 206 (e.g., the data network 140 of FIG. 1). For ease of illustration, FIG. 2 only shows a single UE 202 being connected to the NG-RAN 204; however, in practical implementations, any number of UEs 202 may be present, limited only by the capacity of the network. Any of the NFs illustrated in FIG. 2 and/or described herein may be implemented as a software unit residing on a server (i.e., in the cloud).

The UP NFs may include a User Plane Function (UPF) 208. The UPF 208 is a NF that routes and forwards UP data packets between the base station (cell site; for example, the NG-RAN 204) and the data network 206 (e.g., the Internet). The UPF 208 may be similar to the service and packet gateway functions in a 4G network, but the UPF 208 is cloud-native and can be deployed anywhere to meet service requirements. The UPF 208 can also manage, prioritize, and duplicate data packets as those data packets traverse the network, thus offering redundancy and quality-of-service (QoS) assurance.

The CP NFs may include a Network Slice Selection Function (NSSF) 210, a Network Exposure Function (NEF) 212, a Network Repository Function (NRF) 214, a Policy Control Function (PCF) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, and a Network Data Analytics Function (NWDAF) 230.

The NSSF 210 may be a CP function that provides network slices to the AMF 226. A network slice is an independent, end-to-end logical network that runs on shared physical network infrastructure. The network slice involves the allocation of network resources across all network infrastructure to meet specific service requirements, from the network core to the RAN. Specific requirements may include QoS assurance, security policies, data isolation, dynamic policy management, etc.

The NEF 212 may be a CP function that provides information regarding the NFs that are available to use (by the enterprise customer). The NEF 212 may be similar to the 4G Service Capabilities Exposure Function (SCEF), but the NEF 212 is cloud-native and exposes event information, network monitoring, network control, provisioning capabilities, and policy/charging capabilities externally. This allows the enterprise customer to monitor and affect QoS and charging for devices.

The NRF 214 may be a CP function that allows 5G NFs to be registered, discovered, and subsequently made available to customers. This is a unique capability in the SA 5G network that allows customers to subscribe to the necessary microservices or to have dedicated NFs for their services.

The PCF 216 may be a CP function that provides policies for mobility and session management. The PCF 216 may be similar to the Policy and Charging Rules Function (PCRF) in a 4G network, but the PCF 216 is cloud-native and offers additional capabilities in the 5G network, including event-based policy triggers, resource reservation requests, and access network discovery and selection. The PCF 216 may directly influence QoS and subscriber spending limits, and, as a result, may play a role in the enhanced policy management and control capabilities of the 5G network.

The UDM 218 may be a CP function that manages and stores subscriber and device information, default QoS and prioritization, authorized data channels, maximum bit rates, service continuity provisions, and the like. The UDM 218 may be similar to the Home Subscriber Server (HSS) function in a 5G network, but the UDM 218 is cloud-native and designed for 5G services.

The AF 220 may be a CP function that interacts with the 3GPP Core Network in order to provide services, for example, to support one or more of application function influence on traffic routing, application function influence on service function chaining, accessing the NEF 212, interacting with the PCF 216, time synchronization service, IP multimedia subsystem (IMS) interactions with the 5GC, or packet data unit (PDU) set handling.

The NSSAAF 222 may be a CP function that supports authentication and authorization of slicing with an AAA server (Authentication, Authorization, and Accounting). The NSSAAF 222 may be a unique capability of the SA 5G network that allows customers to access a predefined network slice or a newly requested network slice in real-time (or near real-time) and using their own existing authentication infrastructure.

The AUSF 224 may be a CP function that supports authentication for 3GPP access and untrusted non-3GPP access, and authentication of a UE for a disaster roaming service. The AUSF 224 can act as an authentication server.

The AMF 226 may be a CP function that manages registration, authorization, connection, reachability, and mobility. The AMF 226 may be similar to the Mobility Management Entity (MME) function in a 4G network, but the AMF 226 is cloud-native and supports many additional capabilities unique to 5G. For example, the AMF 226 may also support dynamic updating of network interfaces and cellular sites, greater privacy via the use of a 5G temporary device identity, enhanced security across the user and control planes, and storing of network slice information. The AMF 226 can also select an appropriate PCF for a device or use case.

The SMF 228 may be a CP function that oversees packet data session management, IP address allocation, data tunneling from a cell site base station to the UP function, and downlink notification management. The SMF 228 may perform the tasks of the serving and packet gateways (S-GW & P-GW) in a 4G network, but also allows for CP and UP separation in 5G.

The NWDAF 230 may be a CP function that collects data from pertinent network infrastructure relevant to a customer's services, including UE (device), NFs, network operations and administration, cloud, and edge that can be used for data analytics and insights. The NWDAF 230 may be a unique SA 5G NF that exposes full visibility to network performance and operations as they relate to a customer's key performance indicators (KPIs).

The architecture 200 may further include a plurality of service-based interfaces to provide access to or communication with the various NFs. As illustrated, such service-based interfaces may include an Nnssf interface for the NSSF 210, an Nnef interface for the NEF 212, an Nnrf interface for the NRF 214, an Npcf interface for the PCF 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, and an Nnwdaf interface for the NWDAF 230. FIG. 1 also illustrates several reference points (i.e., interfaces between two NFs or entities), including an N1 interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206.

The above-listed NFs and interfaces are intended to be illustrative and not exhaustive. In practical implementations, the architecture 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a 5G-Equipment Identity Register (5G-EIR), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), or a Trusted WLAN Interworking Function (TWIF).

For purposes of explanation, the technology disclosed herein will be described as being implemented in a 5G O-RAN network; however, in practice, the technology disclosed herein may be implemented with any RAN architecture (including, e.g., any virtualized RAN architecture). Moreover, for purposes of explanation, the systems and methods described herein will be described as being implemented in a network operating using AWS; however, these are merely examples and not limiting. The systems and methods of the present disclosure may be implemented with other web services provider and with other container organization architectures. The methods described herein may be performed by a processing system including at least one electronic processor, where the at least one electronic processor may be or include a processor as described herein (e.g., including one or more individual electronic processors). A data center server is an example of such a processing system that may perform the methods described herein.

As described herein with respect to FIG. 1, the 5GC 140 provides a plurality of 5G core functions, which may reside and/or execute via one or more data centers (e.g., one or more NDCs or RDCs), including, e.g., one or more data center servers. For instance, in some configurations, the data center server(s) may store and execute a set of instructions for executing one or more NFs as described herein. Additionally, in some embodiments, the data center server may be a local server located at corresponding cell site(s) (e.g., as part of an on-site computing platform of a corresponding wireless access point 115 or cell site). Alternatively, or in addition, in some embodiments, the data center server may be a remote cloud server located remotely from the corresponding cell site(s).

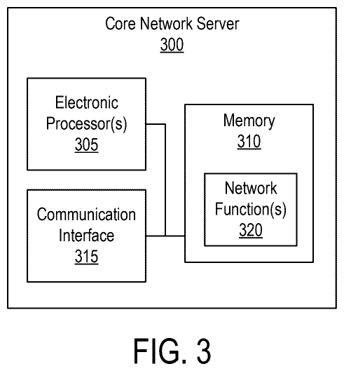

For example, FIG. 3 schematically illustrates an example core network server 300 (e.g., a data center server for the 5GC 140 of FIG. 1) according to some configurations. As illustrated in FIG. 3, the core network server 300 includes an electronic processor 305, a memory 310, and a communication interface 315. The electronic processor 305, the memory 310, and the communication interface 315 may communicate wirelessly, over one or more communication lines or buses, or a combination thereof. The core network server 300 may include additional, different, or fewer components than those illustrated in FIG. 3 in various configurations. The core network server 300 may perform additional or different functionality than the functionality described herein. Also, the functionality (or a portion thereof) described herein as being performed by the core network server 300 may be performed by another component (e.g., another data center server or component of the 5GC 140), distributed among multiple devices (e.g., as part of a cloud service or cloud-computing environment), combined with another component (e.g., another component of the telecommunications network 100), or a combination thereof.

The communication interface 315 may include a transceiver that communicates with other components of the telecommunications network 100, such as, e.g., the data network 145, the RAN 130, including, e.g., the RU(s) 131, DU(s) 132, or CU(s) 133, the KPI server 150, the network performance server 155, the data lake 160, etc. over one or more communication networks or connections. The electronic processor 305 includes one or more electronic processors (e.g., one or more microprocessors, one or more application-specific integrated circuits (ASICs), and/or one or more other suitable electronic device for processing data), and the memory 310 includes a non-transitory, computer-readable storage medium. The electronic processor 305 is configured to retrieve instructions and data from the memory 310 and execute the instructions. For example, as illustrated in FIG. 3, the memory 310 may store one or more network functions 320 (also referred to herein as the NFs 320). The NFs 320 may include, e.g., one or more of the NFs described herein, such as, e.g., with respect to FIG. 2.

Returning to FIG. 1, the telecommunications network 100 may also include a KPI server 150. Although not illustrated in FIG. 1, the KPI server 150 may include similar components as the core network server 300, such as an electronic processor (for example, a microprocessor, an ASIC, or another suitable electronic device), a memory (for example, a non-transitory, computer-readable storage medium), a communication interface, such as a transceiver, for communicating over a communication network (e.g., via the 5GC 140) and, optionally, one or more additional communication networks or connections, and one or more human machine interfaces (e.g., displays, keyboards, touch screens, speakers, mice, etc.).

The KPI server 150 may collect or otherwise determine KPI data 165 associated with the telecommunications network 100. The KPI data 165 may include data or information relating to one or more KPIs. A KPI may be a quantifiable measure of performance over time for a specific objective. For instance, a KPI may be a type of performance measurement. The KPI data 165 may include a measurement (or value) for a corresponding KPI, such as, e.g., a percentage, a ratio, a quantity, a rate, a rate of change, or the like. The KPI(s) may include, e.g., accessibility, retainability, mobility, integrity, availability, utilization, jitter, latency, call delay, registration success rate, infrastructure interrupt times, infrastructure errors, etc. In some configurations, a KPI may be divided or segmented into one or more underlying indicators (underlying KPIs). For instance, a particular KPI may be based on performance measurements of a plurality of underlying indicators (underlying KPIs). As one specific example, an accessibility KPI may be based on (or otherwise divided into) a radio resource control (RRC) setup success rate, an E-UTRAN radio access bearer (ERAB) setup success rate, and call setup success rate. In some instances, a KPI (or an underlying KPI or indicator) may be based on a KPI counter or tracker. As one example, a RRC setup success rate may be determined by tracking (or otherwise counting) a RRC connection success rate and a RRC connection attempt rate (e.g., with a counter at the eNodeB). Below is an example formula for determining the RRC setup success rate:

$${RRCS\_SR}_{s e r v i c e} = \frac{{RRCConnectionSuccess}_{s e r v i c e}}{{RRCConnectionAttempt}_{s e r v i c e}} \times 100 \%$$

As another example, the accessibility KPI may be based on the ERAB setup success rate, where the ERAB setup success rate may be determined by tracking (or otherwise counting) ERAB setup attempts or successful ERAB setups (e.g., with one or more counters at the eNodeB). Below is an example formula for determining the ERAB setup success rate:

$$ERABS\_SR = \frac{E R A B S e t u p S u c c e s s}{E R A B S e t u p Attempt} \times 100 \%$$

As noted above, the KPI data 165 may include a measurement (or value) for a corresponding KPI, such as, e.g., a percentage. Accordingly, in some configurations, the KPI data 165 may include a value associated with the KPI, a value associated with one or more underlying KPIs, a value associated with a KPI counter or tracker, etc. As one specific example, the KPI data 165 may include one or more values for: the accessibility KPI, the radio resource control (RRC) setup success rate, the E-UTRAN radio access bearer (ERAB) setup success rate, the call setup success rate, the RRC connection success rate, the RRC connection attempt rate, the ERAB set up success rate, the ERAB setup attempts, etc.

As noted herein, the KPI server 150 may collect or otherwise determine KPI data 165 associated with the telecommunications network 100. In some configurations, the KPI server 150 may receive data or information relating to one or more KPIs. In some configurations, the KPI server 150 may receive data from one or more counters or trackers of the telecommunications network (e.g., at the eNodeB) (also referred to herein as counter data). Responsive to receiving the counter data, the KPI server 150 may determine a performance measurement (e.g., a KPI) corresponding to the counter data. As one example, the KPI server 150 may receive counter data related to ERAB setup success and ERAB setup attempts and, responsive to receiving that counter data, the KPI server 150 may determine the ERAB setup success rate (or the accessibility KPI). Alternatively, or in addition, the KPI server 150 may receive data or information relating to an underlying indicator or KPI, such as, e.g., the radio resource control (RRC) setup success rate or the E-UTRAN radio access bearer (ERAB) setup success rate, and, responsive to receiving that data or information, the KPI server 150 may determine the accessibility KPI.

In some configurations, the KPI server 150 may receive the KPI data 165 from one or more ecosystems or platforms (e.g., one or more vendor ecosystems), such as, e.g., a transport ecosystem, a core ecosystem, a RAN ecosystem, a platform as a service (PaaS) ecosystem, etc. Accordingly, in some configurations, the KPI data 165 may be sourced from various discrete data sources or points within a network (e.g., the telecommunications network 100).

In some configurations, the KPI server 150 may transmit (or otherwise provide) the KPI data 165 to the data lake 160 for, e.g., storage. As illustrated in FIG. 1, in some configurations, the data lake 160 may store the KPI data 165. As noted herein, in some configurations, the KPI data 165 may be compiled (or aggregated) from various discrete data sources. As such, in some configurations, the data lake 160 may serve as a centralized repository for storing KPI data 165 from various data sources (e.g., various vendor ecosystems). In some configurations, the data lake 160 may store additional or different network data than the KPI data 165. For example, in some configurations, the data lake 160 may store indications or notifications of detected anomalies with respect to the telecommunications network 100.

Although not illustrated in FIG. 1, the data lake 160 may include similar components as the core network server 300, such as electronic processor (for example, a microprocessor, an ASIC, or another suitable electronic device), a memory (for example, a non-transitory, computer-readable storage medium), a communication interface, such as a transceiver, for communicating over a communication network (e.g., via the 5GC 140) and, optionally, one or more additional communication networks or connections, and one or more human machine interfaces.

As noted herein, in some configurations, the telecommunications network 100 may include the network performance server 155. In some instances, the network performance server 155 may be coupled to the 5GC 140, as illustrated in the example of FIG. 1. Accordingly, in some configurations, the network performance server 155 is a separate component from the 5GC 140 such that, e.g., the network performance server 155 resides on top of the 5GC 140. Alternatively, or in addition, in some configurations, the network performance server 155 may be included as a component or element of the 5GC 140.

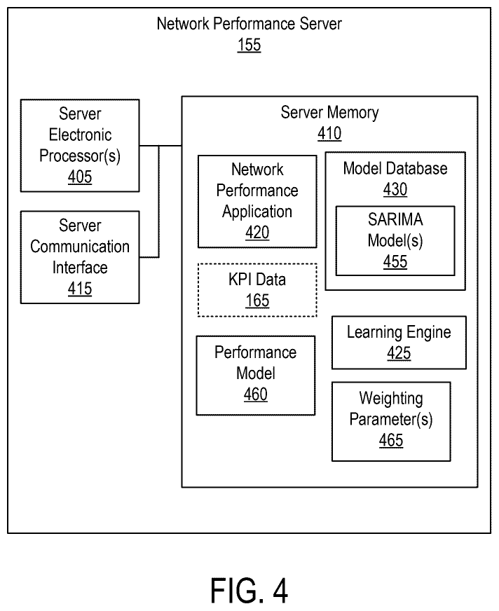

FIG. 4 schematically illustrates an example of the network performance server 155 according to some configurations. As described in greater detail herein, the network performance server 155 may be configured to determine or track network performance with respect to the telecommunications network 100. For instance, in some configurations, the network performance may be indicative of a customer experience with respect to the telecommunications network 100. As described in greater detail herein, in some configurations, the network performance server 155 may determine a singular composite score to describe (or otherwise represent) network performance of the telecommunications network 100 (e.g., as a network health indicator). For instance, in some configurations, the composite score may provide an objective indication of a customer experience with respect to the telecommunications network 100 (e.g., an overall performance level of the telecommunications network 100). The composite score may be tracked over time (temporally tracked) to allow monitoring of network performance of the telecommunications network 100 over time.

As illustrated in FIG. 4, the network performance server 155 includes a server electronic processor 405, a server memory 410, and a server communication interface 415. The server electronic processor 405, the server memory 410, and the server communication interface 415 may communicate wirelessly, over one or more communication lines or buses, or a combination thereof. The network performance server 155 may include additional, different, or fewer components than those illustrated in FIG. 4 in various configurations. The network performance server 155 may perform additional or different functionality than the functionality described herein. Also, the functionality (or a portion thereof) described herein as being performed by the network performance server 155 may be performed by another component or device, distributed among multiple devices (e.g., as part of a cloud service or cloud-computing environment), combined with another component (e.g., another component of the telecommunications network 100), or a combination thereof.

The server communication interface 415 may include a transceiver that communicates with other components of the telecommunications network 100, such as, e.g., the data network 145, the RAN 130, including, e.g., the RU(s) 131, DU(s) 132, or CU(s) 133, the data lake 160, the KPI server 150, the 5GC 140, etc. over one or more communication networks or connections. The server electronic processor 405 includes one or more processors (e.g., one or more microprocessors, one or more ASICs, or one or more other suitable electronic device for processing data), and the server memory 410 includes a non-transitory, computer-readable storage medium. The server electronic processor 405 is configured to retrieve instructions and data from the server memory 410 and execute the instructions.

For example, as illustrated in FIG. 4, the server memory 410 may store a network performance application 420 (also referred to herein as the application 420). The application 420 is a software application executable by the server electronic processor 405 in the example illustrated and as specifically discussed below, although a similarly purposed module can be implemented in other ways in other examples. In some configurations, the application 420 may be a dedicated software application locally stored in the server memory 410 of the network performance server 155. As described in greater detail herein, the application 420 (when executed by the server electronic processor 405) may enable or facilitate the determination and monitoring of intelligent operations health scores with temporal tracking for the telecommunications network 100 in accordance with the technology disclosed herein. In some examples, the application 420 (when executed by the server electronic processor 405) may determine, based on the KPI data 165, a composite score indicative of an overall network health of the telecommunications network 100.

In some configurations, as illustrated in FIG. 4, the server memory 410 may store a learning engine 425 and a model database 430. In some configurations, the learning engine 425 develops one or more models using one or more machine learning functions. Machine learning functions are generally functions that allow a computer application to learn without being explicitly programmed. In particular, the learning engine 425 is configured to develop an algorithm or model based on training data. As one example, to perform supervised learning, the training data includes example inputs and corresponding desired (for example, actual) outputs, and the learning engine 425 progressively develops a model that maps inputs to the outputs included in the training data. As another example, to perform self-supervised learning (“SSL”), a model is trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data). Machine learning performed by the learning engine 425 may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. These approaches allow the learning engine 425 to ingest, parse, and understand data and progressively refine models.

Models generated by the learning engine 425 can be stored in the model database 430. As illustrated in FIG. 4, the model database 430 may be included in the server memory 410 of the network performance server 155. It should be understood, however, that, in some configurations, the model database 430 may be included in one or more separate devices accessible by the network performance server 155 of FIG. 4 (including a remote database, and the like).

As one example, the model database 430 may include one or more time series forecasting models, such as, e.g., one or more seasonal autoregressive integrated moving average (SARIMA) models 455. The SARIMA model 455 may be configured to identify anomalies in data that may have seasonal patterns, including, e.g., short-term and long-term dependencies within the data. As such, the SARIMA model 455 may identify (or otherwise determine) both non-seasonal and seasonal patterns in data.

The SARIMA model 455 may include a plurality of components, including, e.g., a seasonal component, an autoregressive component, an integrated component, and a moving average component. The seasonal component refers to repeating patterns in the data (e.g., recurring fluctuations or seasonal patterns). Such a repeating pattern may repeat (or recur) at a regular interval, such as, e.g., daily, monthly, yearly, hourly, etc. The autoregressive component models the relationship between a current data point of the series and its past values (e.g., specifically at seasonal lags). The autoregressive component may capture autocorrelation of the data (e.g., how correlated the data is with itself over time). The integrated component (also referred to as seasonal differencing) indicates differencing, which transforms non-stationary data into stationary data (e.g., how many differences are required to achieve stationarity). For instance, seasonal differencing may refer to a process of subtracting time series data by a lag that equals the seasonality, which may facilitate the removal of the seasonal component making the data stationary. As such, the integrated component may account for the differencing to remove seasonality from the series. The moving average component models the dependency between a current data point in the series and past errors (e.g., residual errors of previous predictions at seasonal lags), which may facilitate the capture of short-term noise in the data. The SARIMA model 455 may be represented as:

$$SARIMA ( p , d , q ) ( P , D , Q , s )$$

where: s is the seasonal period; P is the number of seasonal autoregressive terms; D is the number of seasonal differences; and Q is the number of seasonal moving average terms. With respect to the above notation, uppercase notation represents the seasonal parts of the SARIMA model 455 and lowercase notation represents the non-seasonal parts of the SARIMA model 455.

The SARIMA model 455 may be mathematically represented as follows:

$$( 1 - {ϕ}_{1} B ) ( 1 - {Φ}_{1} {B}^{S} ) ( 1 - B ) ( 1 - {B}^{S} ) {y}_{t} = ( 1 + {θ}_{1} B ) ( 1 + {Θ}_{1} {B}^{S} ) ε t$$

where: yₜ is the observed time series at time t; B is the backward shift operator, representing the lag operator (Byₜ=yₜ₋₁); φ₁ is the non-seasonal autoregressive coefficient; Φ₁ is the seasonal autoregressive coefficient; θ₁ is the non-seasonal moving average coefficient; Θ₁ is the seasonal moving average coefficient; s is the seasonal period; and et is the white noise error term at time t.

In some configurations, as described in greater detail herein, the SARIMA model 455 may be applied to the KPI data 165 for anomaly detection and prediction functionality performed by the network performance server 155 as part of monitoring or tracking network performance of the telecommunications network 100 using a composite score. For instance, in some configurations, the KPI data 165 may be provided as an input to the SARIMA model 455 and the SARIMA model 455 may detect one or more anomalies in the KPI data 165, as described in greater detail herein. In some configurations, the SARIMA model 455 may output anomaly data. The anomaly data may include (or otherwise indicate) the detected anomaly (or an indication thereof). Alternatively, or in addition, the anomaly data may include data related to the detected anomaly, such as, e.g., a KPI value, a KPI, or another network parameter related to the detected anomaly. As one example, the anomaly data may indicate that an anomaly was detected for a first KPI, a KPI value of the first KPI, a severity of the anomaly detected for the first KPI, etc.

As illustrated in FIG. 4, the server memory 410 may include a performance model 460. In some configurations, the performance model 460 may be a model developed by the learning engine 425. For instance, in some configurations, the performance model 460 may be a machine learning or artificial intelligence model that is trained to determine a composite score for the telecommunications network 100. As described in greater detail herein, the performance model 460 may determine a composite score for the telecommunications network 100. As noted herein, the composite score may be a singular performance metric (or health indicator) that represents or otherwise indicates an overall health or performance of the telecommunications network 100 (e.g., with respect to customer experience). In some configurations, the performance model 460 may determine the composite score based on the KPI data 165, anomaly data generated by the SARIMA model 455 (or another model), etc.

The server memory 410 may include one or more weighting parameters 465. As described in greater detail herein, the weighting parameter(s) 465 may be utilized (or otherwise implemented) by the performance model 460 to determine the composite score. For example, the weighting parameters 465 may define (or otherwise establish) how to weigh various data points (e.g., KPI values, KPIs, anomalies, etc.). As one example, when the KPI data 165 indicates diminished or reduced coverage due to a density of POPs within the telecommunications network while also indicating good roaming profiles available (such that a customer experience is not impacted), an accessibility KPI may not be an issue (e.g., not indicate an anomaly). As such, the performance model 460 may implement various weighting parameters 465 to account for situations where customer experience (or network performance) is not impacted (despite a portion of the KPI data 165 indicating a potential adverse impact on the telecommunications network 100).

The server memory 410 may include additional, different, or fewer components in different configurations than illustrated in FIG. 4. For example, in some configurations, the KPI data 165 may be stored in the server memory 410. Alternatively, or in addition, in some configurations, one or more components of the server memory 410 may be combined into a single component, distributed among multiple components, or the like. Alternatively, or in addition, in some configurations, one or more components of the server memory 410 may be stored remotely from the network performance server 155, or, in a remote database, another server, a remote user device, an external storage device, or the like.

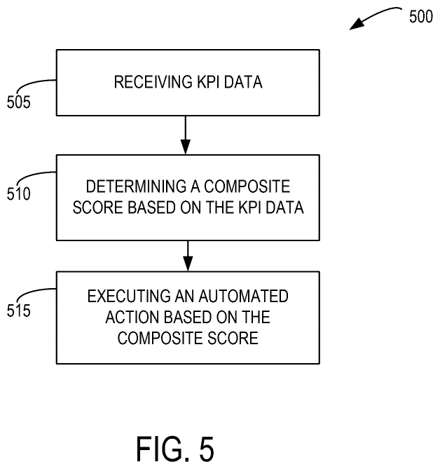

FIG. 5 is a flowchart illustrating an example method 500 to perform temporal operations health scores tracking in telecommunication networks in accordance with some configurations. The method 500 is described as being performed by the network performance server 155 and, in particular, the server electronic processor(s) 405. However, as noted above, the functionality (or a portion thereof) described with respect to the method 500 may be performed by other devices, such as, e.g., another server or device within the telecommunications network 100, or distributed among a plurality of devices, such as a plurality of servers included in a cloud service. Thus, although described as begin performed by the network performance server 155, the method 500 may also be described as being performed by a processing system including one or more electronic processors (e.g., another processor or processors of the telecommunication network 100).

As illustrated in FIG. 5, the server electronic processor 405 may receive the KPI data 165 (at block 505). As noted herein, in some configurations, the KPI data 165 may be stored in the data lake 160. Accordingly, in some configurations, the server electronic processor 405 may receive (or otherwise retrieve) the KPI data 165 from the data lake 160. Alternatively, or in addition, in some configurations, the KPI data 165 may be stored in the server memory 410. In such configurations, the server electronic processor 405 may receive (or otherwise retrieve) the KPI data 165 from the server memory 410. In some configurations, the KPI data 165 may be time series data. As such, in some configurations, the server electronic processor 405 may continuously (or near continuously) receive the KPI data 165. For example, the server electronic processor 405 may receive the KPI data 165 in real time (or near real time).

The server electronic processor 405 may determine a composite score based on the KPI data 165 (at block 510). As described herein, a composite score may be or include a single composite score that indicates an overall health (or performance) of the telecommunications systems 100. In some examples, the composite score may be a numerical value on a scale (e.g., 0-1, 1-10, 1-100, 1-1000, etc.) or may be a ranking on a multi-level scale of descriptive words have a particular rank sequence (e.g., very poor, poor, acceptable, good, very good, etc.). In some examples, the descriptive words may correspond to respective ranges of numerical values on a numerical scale and, thus, the server electronic processor 405 may generate a numerical score and translate the score to one of the descriptive words on the multi-level scale. Accordingly, the composite score may be a underlying numerical value and may have a corresponding descriptive word. For instance, in some configurations, the composite score may provide an objective indication of a customer experience with respect to the telecommunications network 100 (e.g., an overall performance level or health of the telecommunications network 100). The composite score may be tracked over time (temporally tracked) to allow monitoring of network performance of the telecommunications network 100 over time.

In some configurations, the server electronic processor 405 may determine the composite score based on a subset of the KPI data 165. For instance, the server electronic processor 405 may determine the composite score based on KPI data related to KPIs indicative of user experience for the telecommunications network 100, such as, e.g., an accessibility KPI, an availability KPI, etc. In some configurations, the server electronic processor 405 may extract (or otherwise identify) a portion (or subset) of the KPI data 165 relating to user experience for the telecommunications network 100. Alternatively, or in addition, in some configurations, when the server electronic processor 405 receives the KPI data 165 (e.g., at block 505 of FIG. 5), the KPI data 165 may be a subset of KPI data that specifically relates to user experience for the telecommunications network 100. For instance, the server electronic processor 405 may only receive KPI data related to user experience for the telecommunications network 100.

In some configurations, the server electronic processor 405 may determine the composite score using the performance model 460, the weighting parameter(s) 465, or a combination thereof. In some configurations, the composite score may include a service availability composite score, a customer experience composite score, or a combination thereof. For instance, in some cases, the composite score may be split into two categories (e.g., a service availability composite score and a customer experience composite score). The composite score may reflect an overall system health, with higher values (or scores) indicating better performance and lower values (or scores) signifying degradation or anomalies. In some instances, the technology disclosed herein provides a building block approach where additional metrics may be brought into the approached disclosed herein seamlessly with contextual weightages based on, e.g., national, regional, market, AOI, cluster, or site level to simplify the health evaluation at any level using composite metrics (or scores).

In some configurations, the service availability composite score may integrate one or more metrics (e.g., a first metric M1 and a second metric M2) to provide a single score (e.g., between 0 and 10). In some examples, the service availability composite score may integrate network service availability (e.g., M1) and a site availability count (e.g., M2). Service availability KPI may be represented as: (cellavailpmperiodtime−cellunavailabletimedown+cellunavailabletimees)/(count(distinct nrcgi)*60*60). Site availability count may represent how many cell sites are down at any given time.

In some examples, the first metric M1 (e.g., network service availability) may be a percentage-based metric with the following thresholds: Ideal: M1≥99.55%; marginal deterioration: M1<99.33%; or severe deterioration: ≤99.20%. In some examples, the second metric M2 (e.g., the site availability count) may be a count-based metric with the following thresholds: ideal: M2≤30; moderate deterioration: 30<M2≤100; and severe anomaly: M2>100. Following this example, the server electronic processor 405 may determine the composite score (e.g., the service availability composite score) by determining a sub-score for the first metric M1, determining a sub-score for the second metric M2, and combining the sub-scores to determine the composite score (e.g., the service availability composite score). In some instances, the server electronic processor 405 may determine the sub-score for the first metric M1 by normalizing the first metric M1 using a range, such as, e.g., 99.55% to 99.33%, wherein M1norm=(99.55−M1)/(99.55−99.33). The server electronic processor 405 may then transform M1 into a score using the following equation: S_M1=max(10−10×M1_norm, 0), where the characteristics may include, e.g., the following: S_M1=10 when M1=99.55%; S_M1=9.0 when M1=99.33%; and S_M1<8.0 when M1<99.20%. In some instances, the server electronic processor 405 may determine the sub-score for the second metric M2 by transforming the second metric into a score using the following equation: S_M2=max (10−(M2/2500), 0), where the characteristics may include, e.g., the following: S_M2=10 for M2≤30; S_M2 decreases linearly as M2 increases; and S M2=0 when M2≥25000. The server electronic processor 405 may combine the two sub-scores using, e.g., a weighted averaging, such that, e.g., the composite score (e.g., the service availability composite score) may equal W1×S_M1+W2×S_M2, where the default weights may include, e.g., W1=0.3 (for M1) and W2=0.7 (for M2).

In some implementations, for balanced sensitivity, the first metric M1 (e.g., network service availability) may be a driver for network health when percentages deviate from ideal values (e.g., <99.33%) and the second metric M2 (e.g., site availability count) may have a greater influence when counts exceed acceptable thresholds (e.g., >30). In some implementations, for threshold behavior, scores may transition smoothly, allowing meaningful differentiation between minor and sever anomalies.

In some instances, thresholds for composite score may be tuned or changed to growing and changing demands of the operator network. The following are example thresholds: 10.0: near-perfect performance (M1≥99.55%, M2≤30); 9.0: marginal deterioration (M1≈99.33%, M2≤100); and 8.0 and below: significant or severe anomalies (M1<99.20%, M2>100).

In some configurations, the customer experience composite score may incorporate one or more metrics (e.g., a first metric M1, a second metric M2, and a third metric M3) to provide a single score (e.g., between 0 and 10). In some examples, the customer experience composite score may incorporate voice accessibility (e.g., as the first metric M1), data accessibility (e.g., as the second metric M2), and call drop rate (CDR) (e.g., as the third metric M3).

In some examples, accessibility metric may be computed for voice and data using the following: VONR Session Setup SR (5QI-1)=VONR_Call_Setup_Successes/VoNR_Call_Setup_Attempt)*100; and Data Session Setup SR (5QI-9)=(Data_Call_Setup_Success/Data_Call_Setup_Attempt)*100. SIP call drop rate may be procured from call detail record data.

In some examples, the first metric M1 (e.g., voice accessibility) may be related to the following thresholds: ideal: M1≥99.2%; marginal deterioration: M1<99.00% (Score~9); and severe deterioration: M1<98.80% (Rapid drop in score). The second metric M2 (e.g., data accessibility) may be related to the following thresholds: Ideal: M2≥99.2%; marginal deterioration: M2<99.00% (Score ~9); and severe deterioration: M2<98.80% (Gradual score reduction). The third metric M3 (e.g., call drop rate) may be associated with the following thresholds: Ideal: M3≤0.80%; marginal deterioration: M3≤0.90% (Score ~8.5); and severe anomaly: M3>0.90% (Significant score reduction).

Following this example, the server electronic processor 405 may determine the composite score (e.g., the customer experience composite score) by determining a sub-score for the first metric M1, determining a sub-score for the second metric M2, determining a sub-score for the third metric M3, and combining the sub-scores to determine the composite score (e.g., the customer experience composite score). The server electronic processor 405 may determine the sub-score for the first metric M1 by normalizing the first metric M1 using the following: M1_norm=(99.2−M1)/(99.2−99.00). The server electronic processor 405 may determine the sub-score for the first metric M1 using the following: S_M1=max (10−10×M1_norm, 0), where the characteristics may include the following: S_M1=10 when M1=99.2%; S_M1=9.0 when M1=99.00%; and Rapid score drop below 99.00%.

The server electronic processor 405 may determine the sub-score for the second metric M2 by normalizing the second metric M2 using the following: M2_norm=(99.2−M2)/(99.2−99.00). The server electronic processor 405 may determine the sub-score for the second metric M2 using the following: S_M2=max (10−10×M2_norm, 0), where the characteristics may include the following: S_M2=10 when M2=99.2%; S_M2=9.0 when M2=99.00%; and Gradual score reduction below 99.00%.

The server electronic processor 405 may determine the sub-score for the third metric M3 by normalizing the third metric M3 using the following: M3_norm=(M3-0.80)/(0.90−0.80). The server electronic processor 405 may determine the sub-score for the third metric M3 using the following: S_M3=max (10−20×M3_norm, 0), where the characteristics may include the following: S_M3=10 when M3≤0.80%; S M3=8.0 when M3=0.90%; and Severe score reduction above 0.90%.

The server electronic processor 405 may combine the three sub-scores with weights, such that, e.g., the composite score (e.g., the customer experience composite score) may equal W1×S_M1+W2×S_M2+W3×S_M3, where the default weights may include, e.g., W1=0.5 (Voice Accessibility); W2=0.3 (Data Accessibility); and W3=0.2 (Call Drop Rate).

In some configurations, the characteristics of the customer experience composite score may include, e.g., voice accessibility (e.g., the first metric M1) may have the highest impact on the composite score, with rapid deterioration below 99.00%; data accessibility (e.g., the second metric M2) may have moderate impact, with a gradual decline in the score below 99.00%, or the call drop rate (e.g., the third metric M3) may be a metric with severe penalties for rates exceeding 0.90%.

In some implementations, the customer experience composite score may include thresholds that may be tuned or changed to growing and changing demands of the operator network. Example thresholds may include, e.g., 10.0: Perfect performance (M1≥99.2%, M2≥99.2%, M3≤0.80%); 9.0: Marginal deterioration (M1/M2~99.00%, M3~0.90%); and 8.0 and below: Significant anomalies (M1/M2<98.80%, M3>0.90%).

The server electronic processor 405 may execute an automated action based on the composite score (at block 515). In some configurations, the server electronic processor 405 may execute the automated action with respect to the telecommunications network 100. The server electronic processor 405 may execute the automated action responsive to determining the composite score. As described herein, in some instances, the server electronic processor 405 may execute the automated action by logging the composite score (or adding the composite score to trend data for the telecommunications network 100), providing a notification or warning based on the composite score, etc.

In some examples, the server electronic processor 405 may add the composite score (or an indication thereof) as a data point to trend data for the telecommunications network 100. Such trend data may represent an overall health or performance trend of the telecommunications network 100. For instance, the trend data may include a collection of composites scores that were temporally tracked, such that an overall health of the telecommunications network 100 may be determined at any given point in time. As one example, the server electronic processor 405 may enable a user to interact with (or access) the composite score (or the trend data) such that the user may evaluate the health or performance of the telecommunications network 100 over time. In some examples, the server electronic processor 405 may generate a graphical representation of the composite score or the trend data for display to a user via a user device (e.g., the UE 110 of FIG. 1). As one specific example, the server electronic processor 405 may generate a graphical user interface that indicates the composite score or the trend data, such as, e.g., as a table or chart, where the graphical user interface may be provided (or otherwise transmitted to) a user device for display to a user of the user device.

Alternatively, or in addition, in some configurations, the server electronic processor 405 may provide an automated notification or alert responsive to determining the composite score. In some instances, the automated notification may indicate the composite score, the KPI data 165 (or KPI) associated with the composite score, etc. In some configurations, the notification may be provided to a user device of a user, such as, e.g., a network management or administrative entity of the telecommunications network 100.

In some configurations, the automated notification may be a service ticket (or a maintenance ticket). In some examples, the automated notification may be an actionable ticket or an informational ticket, such as, e.g., based on the composite score, the KPI data 165 associated with the composite ticket, etc. For instance, a composite score indicative that the telecommunications network 100 is unhealthy (overall) may trigger an actionable ticket (e.g., a request for service) while a composite score indicative that the telecommunications network 100 is healthy (overall) may trigger an informational ticket (e.g., a flag or record of the composite score, as trend data). In some configurations, the automated notification may be transmitted (or otherwise provided) to different devices (or end users) based on, e.g., the composite score, the KPI data 165 associated with the composite score, etc.

Accordingly, in some configurations, the technology disclosed herein may facilitate (or otherwise allow) a user to interact with the composite score such that the user can quickly evaluate an overall health of the telecommunications network 100 (as opposed to a user having to analyze and interpret multiple KPIs in order to determine an overall health or performance of the telecommunications network 100, which in some instances may be a subjective determination). As one example, while an accessibility KPI may indicate an adverse impact on the telecommunications network 100, users of the telecommunication network 100 may be able to access a roaming network such that the actual experience of those users is not adversely impacted (as suggested by the accessibility KPI). Following this example, in some configurations, the composite score may be structured such that the composite score provides a true score of how the telecommunications network 100 is operating from a perspective of a user of the telecommunications network 100.

In some configurations, the server electronic processor 405 may determine whether the composite score satisfies one or more criteria. A criterion may establish (or otherwise define) a threshold value (or a threshold value range) indicative of a corresponding health or performance levels. As one example, the criterion may establish a first threshold value associated with a first performance level (e.g., healthy), a second threshold value associated with a second performance level (e.g., moderately healthy), and a third threshold value associated with a third performance level (e.g., unhealthy). Following this example, when the composite value satisfies the first threshold value (as a first criterion), the server electronic processor 405 may determine that the telecommunications network 100 is healthy (e.g., user experience of the telecommunications network 100 are not adversely impacted or diminished). When the composite value satisfies the second threshold value (as a second criterion), the server electronic processor 405 may determine that the telecommunications network 100 is moderately healthy (e.g., user experience of the telecommunications network 100 is moderately or minimally impacted or diminished). When the composite value satisfies the third threshold value (as a third criterion), the server electronic processor 405 may determine that the telecommunications network 100 is unhealthy (e.g., user experience of the telecommunications network 100 is significantly impacted or diminished).

In some configurations, the server electronic processor 405 may execute the automated action based on whether the composite score satisfies one or more criteria. For instance, in some configurations, the server electronic processor 405 may execute the automated action responsive to the composite score satisfying a criterion (or criteria). In some examples, the server electronic processor 405 may determine (or otherwise select) the automated action, from a plurality of automated actions, based on whether the composite score satisfies one or more criteria. Alternatively, or in addition, the server electronic processor 405 may determine (or otherwise select) the automated action based on which criteria the composite score satisfies. As one example, the server electronic processor 405 may select a first automated action to execute when the composite score satisfies a first criterion and may select a second automated action to execute when the composite score satisfies a second, difference criterion.

In some configurations, the server electronic processor 405 may determine (or otherwise select) multiple automated actions. For example, the server electronic processor 405 may select a first automated action when the composite score satisfies a first criterion and may select the first automated action and a second automated action when the composite score satisfies a second criterion. As a specific example, when the server electronic processor 405 determines that the composite score satisfies a first criterion, which indicates that the telecommunications network 100 is healthy overall, the server electronic processor 405 may select a first automated action, which may include logging (or adding) the composite score to trend data that tracks health of the telecommunications network. Following this specific example, when the server electronic processor 405 determines that the composite score satisfies a second criterion, which indicates that the telecommunications network 100 is unhealth overall, the server electronic processor 405 may select the first automated action and a second automated action, where the first automated action may include logging (or adding) the composite score to trend data that tracks health of the telecommunications network and the second automated action may include providing an automated notification or warning to a remote device of a user (e.g., a network administrator or entity).

In some instances, when the server electronic processor 405 determines that the composite score satisfies a first criterion, which indicates that the telecommunication network 100 is healthy overall (e.g., user experience is not adversely impacted or diminished), the server electronic processor 405 may not execute an automated action. For instance, in some configurations, the server electronic processor 405 may execute the automated action(s) responsive to determining that the composite score indicates some degree of adverse impact on user experience for the telecommunications network 100 and may refrain from executing the automated actions) responsive to determining that the composite score does not indicate some degree of adverse impact on user experience for the telecommunications network 100.

As noted herein, in some instances, the technology disclosed herein may determine the composite score for the telecommunications network 100 based on anomaly data. For instance, in some configurations, the server electronic processor 405 may determine the composite score based on anomaly data and the KPI data 165.

In such configurations, the server electronic processor 405 may provide the KPI data 165 to the SARIMA model(s) 455. As described herein, the SARIMA model(s) 455 may be configured to detect an anomaly in the performance of the telecommunications network based on, e.g., the KPI data 165. For instance, the SARIMA model(s) 455 may ingest and analyze the KPI data 165 and determine whether a value or measurement included in the KPI data 165 indicates an anomaly. A value or measurement may indicate an anomaly when that value or measurement is outside of an expected or normal range. For instance, when a value or measurement exceeds an associated threshold, the value or measurement may be indicative of an anomaly. As one example, an anomaly may include a jitter that exceeds a corresponding threshold. As another example, an anomaly may include a call drop rate that exceeds a corresponding threshold.

As described herein, each of the SARIMA model(s) 455 may be a time series forecasting model that handles seasonal data. For instance, the SARIMA model(s) 455 may account for fluctuations, such as, e.g., recurring fluctuations or seasonal patterns in the KPI data 165, when detecting or predicting anomalies. As one specific example, an accessibility percentage may normally be between 80-90%. However, on Friday evenings, the accessibility percentage regularly decreases to be between 75-80%. The SARIMA model(s) 455 may determine (or otherwise recognize) such a regular decrease to be a recurring fluctuation or seasonal pattern with respect to the KPI data 165 for accessibility. Following this example, the SARIMA model(s) 455 may detect anomalies based on the seasonal pattern (e.g., a 5% decrease on Friday evenings). Following this example, when the accessibility percentage is 76% on a Friday evening, the SARIMA model(s) 455 may not detect an anomaly. As another example, when the accessibility percentage is 76% on a Thursday evening or on a Friday morning, the SARIMA model(s) 455 may detect an anomaly. As yet another example, when the accessibility percentage is 65% on a Friday evening, the SARIMA model(s) 455 may detect an anomaly.

As described herein, the SARIMA model(s) 455 may be configured to analyze the KPI data 165 at varying granularity. As one example, the SARIMA model(s) 455 may analyze the accessibility KPI, the RRC setup success rate, the ERAB setup success rate, the RRC connection success rate, the RRC connection attempt rate, the ERAB setup success count, the ERAB setup attempt count, etc. By allowing for an analysis at varying granularity, the technology disclosed herein advantageously may detect or predict anomalies with more accuracy as well as breadth. For example, the accessibility KPI may not be indicative of an anomaly, but the RRC connection attempt rate may be indicative of an anomaly. Following this example, an anomaly detection approach that limits analysis to a single level (e.g., the accessibility KPI) would fail to detect the anomaly with respect to the RRC connection attempt rate.

In some configurations, the SARIMA model(s) 455 may be configured to detect an anomaly based on a particular combination of values or measurements included in the KPI data 165. As one example, the SARIMA model(s) 455 may be configured to detect an anomaly with the accessibility KPI when the ERAB setup success rate and the RRC setup success rate are both indicative of an anomaly.

In some configurations, a SARIMA model may be specific to a particular KPI (or group of KPIs, such as, e.g., KPIs relating to accessibility). For example, a SARIMA model may be specifically configured or tuned for a specific KPI (or group of KPIs). As one example, a first SARIMA model may be specifically tuned for a first KPI (e.g., an accessibility KPI) and a second SARIMA model may be specifically tuned for a second KPI (e.g., a mobility KPI). As one specific example, a first SARIMA model may be specifically tune for detecting anomalies with respect to the mobility KPI while a second SARIMA model may be specifically tune for detecting anomalies with respect to an intra-frequency handover out success rate (an underlying KPI of the mobility KPI). Alternatively, or in addition, in some configurations, a single SARIMA model may be implemented with respect to various KPIs. For instance, a single SARIMA model may be applied to multiple KPIs (e.g., the mobility KPI and the accessibility KPI).

The server electronic processor 405 may receive, from the SARIMA model(s) 455, anomaly data, which may include (or is indicative of) an anomaly detected in the KPI data 165. The server electronic processor 405 may determine the composite score (e.g., at block 510 of FIG. 5) based on the KPI data 165, the anomaly data, or a combination thereof. For instance, in some configurations, the server electronic processor 405 may provide the KPI data 165, the anomaly data, or a combination thereof to the performance model 460 as input. Responsive to receiving the KPI data 165, the anomaly data, or a combination thereof, the performance model 460 may determine the composite score based on the KPI data 165, the anomaly data, or a combination thereof. As described herein, in some configurations, the performance model 460 may utilize (or otherwise be implemented using) the weighting parameter(s) 465. The performance model 460 may provide the composite score as an output, where the composite score is based on the KPI data 165, the anomaly data, or a combination thereof.

In some configurations, the server electronic processor 405 may execute the automated action, based on the anomaly data. For instance, in some examples, the server electronic processor 405 may log (or add) the anomaly data (or a portion thereof) to the trend data in addition to the composite score. As another example, the server electronic processor 405 may provide the automated notification such that the automated notification indicates or otherwise includes the anomaly data (or a portion thereof). For example, the automated notification may provide information or data associated with the anomaly, such as, e.g., a type of anomaly, a portion of the KPI data 165 associated with (or otherwise indicative of) the anomaly, a KPI associated with the anomaly, etc.

Other examples and uses of the disclosed technology will be apparent to those having ordinary skill in the art upon consideration of the specification and practice of the technology disclosed herein. The specification and examples given should be considered exemplary only, and it is contemplated that the appended claims will cover any other such embodiments or modifications as fall within the true scope of the technology disclosed herein.

The Abstract accompanying this specification is provided to enable the United States Patent and Trademark Office and the public generally to determine quickly from a cursory inspection the nature and gist of the technical disclosure and in no way intended for defining, determining, or limiting the present technology disclosed herein or any of its embodiments.

What is claimed is:

1. A system to perform temporal operations health score tracking in telecommunication networks, the system comprising:
a processing system comprising one or more electronic processors, the processing system configured to:
receive key performance indicator (KPI) data relating to a plurality of KPIs describing a performance of a telecommunications network;
determine, based on the KPI data, a composite score indicative of an overall performance of the telecommunications network; and
responsive to determining the composite score, execute an automated action with respect to the telecommunications network.

2. The system of claim 1, wherein the composite score is to indicate an overall network health of the telecommunications network.

3. The system of claim 1, wherein the processing system is configured to:
determine whether the composite score satisfies a criterion; and
responsive to the composite score satisfying the criterion, provide an automated notification of the composite score to a remote device.

4. The system of claim 1, wherein the processing system is configured to determine the composite score based on a subset of the KPI data, wherein the subset of the KPI data is associated with a subset of the plurality of KPIs that is indicative of customer experience with respect to the telecommunications network.

5. The system of claim 1, wherein the KPI data is time series data.

6. The system of claim 1, wherein the plurality of KPIs includes at least one of: an accessibility KPI, a retainability KPI, a mobility KPI, an integrity KPI, an availability KPI, or a utilization KPI.

7. The system of claim 1, wherein the processing system is configured to:
determine, based on the KPI data, anomaly data related to the telecommunications network; and
determine the composite score based on the KPI data and the anomaly data.

8. The system of claim 7, wherein the processing system is configured to determine the anomaly data using a seasonal autoregressive integrated moving average (SARIMA) model.

9. The system of claim 7, wherein the anomaly data includes data related to a presence of an anomaly within the KPI data.

10. A method to perform temporal operations health scores tracking in telecommunication networks, the method comprising:
receiving, with a processing system comprising one or more electronic processors, key performance indicator (KPI) data relating to a plurality of KPIs describing a performance of a telecommunications network;
determining, with the processing system, based on the KPI data, a composite score indicative of an overall performance of the telecommunications network; and
responsive to determining the composite score, executing, with the processing system, an automated action with respect to the telecommunications network.

11. The method of claim 10, wherein determining the composite score includes determining a composite score indicative of an overall health of the telecommunications network.

12. The method of claim 10, further comprising:
determining, with the processing system, whether the composite score satisfies a criterion; and
responsive to the composite score satisfying the criterion, providing, with the processing system an automated notification of the composite score to a remote device.

13. The method of claim 10, wherein determining, with the processing system, the composite score includes determining, with the processing system, the composite score based on a subset of the KPI data, wherein the subset of the KPI data is associated with a subset of the plurality of KPIs that is indicative of user experience with respect to the telecommunications network.

14. The method of claim 10, wherein receiving, with the processing system, the KPI data includes receiving time series data, wherein the plurality of KPIs includes at least one of: an accessibility KPI, a retainability KPI, a mobility KPI, an integrity KPI, an availability KPI, or a utilization KPI.

15. The method of claim 10, further comprising:
determining, with the processing system, using a seasonal autoregressive integrated moving average (SARIMA) model, anomaly data based on the KPI data, the anomaly data related to a presence of anomalies within the KPI data, wherein the composite score is determined based on the anomaly data and the KPI data.

16. A non-transitory computer-readable medium storing instructions that, when executed by one or more electronic processors of a processing system in a telecommunications network, cause the processing system to perform operations comprising:
receiving key performance indicator (KPI) data relating to a plurality of KPIs describing a performance of a telecommunications network;
determining, based on the KPI data, a composite score indicative of an overall performance of the telecommunications network; and
responsive to determining the composite score, executing an automated action with respect to the telecommunications network.

17. The computer-readable medium of claim 16, further comprising:
determining whether the composite score satisfies a criterion; and
responsive to the composite score satisfying the criterion, providing an automated notification of the composite score to a remote device.

18. The computer-readable medium of claim 16, further comprising:
determining, based on the KPI data, anomaly data related to the telecommunications network; and
determining the composite score based on the KPI data and the anomaly data.

19. The computer-readable medium of claim 18, wherein determining the anomaly data includes determining the anomaly data using a seasonal autoregressive integrated moving average (SARIMA) model.

20. The computer-readable medium of claim 18, wherein determining the anomaly data includes determining data related to a presence of an anomaly within the KPI data.
